(19) United States
(12) Patent Application Publication
(10) Pub. No.: US 2017/0326735 A1
(43) Pub. Date: Nov. 16, 2017

(54) ROBOT HAND

(71) Applicant: LIFE ROBOTICS INC., Tokyo (JP)

(72) Inventor: Woo-Keun YOON, Tokyo (JP)

(21) Appl. No.: 15/659,185

(22) Filed: Jul. 25, 2017

Related U.S. Application Data
(63) Continuation of application No. PCT/JP2016/051626, filed on Jan. 20, 2016.

(30) Foreign Application Priority Data
Jan. 31, 2015 (JP) 2015-018011

(51) Int. Cl. B25J 15/06; B25J 15/00

(52) U.S. Cl. CPC B25J 15/0683; B25J 15/0028

(57) ABSTRACT

An object of an embodiment is to provide a robot hand with high versatility for various kinds of workpieces. A robot hand according to the embodiment has a pair of grasping sections that are disposed to face each other to grasp a workpiece. The pair of grasping sections are equipped with a pair of workpiece contact sections. The pair of grasping sections are moved in directions to move close to and separate from each other by a moving mechanism. The workpiece contact section is a vacuum suction section including flexibility. The vacuum suction section grasps a workpiece while vacuum-sucking the workpiece.

### CROSS-REFERENCE TO RELATED APPLICATIONS

This application is continuation application of International Patent Application No. PCT/JP2016/051626 filed on Jan. 20, 2016, which is based upon and claims the benefit of priority from the prior Japanese Patent Application No. 2015-018011, filed Jan. 31, 2015 the entire contents of which are incorporated herein by reference.

### FIELD

Embodiments described herein relate generally to a robot hand.

### BACKGROUND

Robotic devices are applied to various workplaces such as manufacturing lines, medical care and nursing care, and are expected to be applied to more fields in the future. In particular, in the actual manufacturing lines, the kind of workpieces and work contents are diverse. For example, resin tube containers include excellent flexibility, elasticity and restorability, but when the resin tube containers are handled by robotic devices and the like in the manufacturing lines, the low self retainability itself for the shapes due to these characteristics causes difficulty in handling. Further, a robot hand is often designed individually in accordance with the properties such as the shape, dimensions, weight and characteristics of the workpieces, and cannot help having relatively low versatility. Furthermore, a single manufacturing line treats two kinds or more kinds of workpieces in some cases, and in such a case, there is a need to equip the robotic device with a plurality of kinds of robot hands, or to install a plurality of robotic devices themselves.

### BRIEF SUMMARY OF INVENTION

An object is to provide a robot hand with high versatility to various kinds of workpieces.

A robot hand according to the present embodiment includes a pair of grasping sections adapted to grasp a workpiece, the pair of grasping sections being disposed to face each other, a pair of workpiece contact sections attached to the pair of grasping sections, and a moving mechanism that moves the pair of grasping sections in directions to move close to and separate from each other, wherein the workpiece contact sections are vacuum suction sections including flexibility.

### BRIEF DESCRIPTION OF THE VIEWS OF THE DRAWING

FIG. 1 is an external perspective view of a robotic device equipped with a robot hand according to the present embodiment;

FIG. 2 is an external perspective view of the robot hand in FIG. 1;

FIGS. 3A and 3B are front views of the robot hand in FIG. 2 in a separated state and a closed state, respectively;

FIGS. 4A and 4B are bottom views of the robot hand in FIG. 2 in a separated state and a closed state, respectively;

FIG. 5 is a side view of the robot hand in FIG. 2;

FIG. 6 is are vertical sectional view of a vacuum suction section of the robot hand in FIG. 2; and

FIGS. 7A to 7C are front views illustrating work gripping states by the robot hand according to the present embodiment.

### DETAILED DESCRIPTION

A robot hand according to an embodiment of the present invention is described below with reference to the drawings. The robot hand according to the present embodiment is mainly used by being fitted to a robotic device. In the following description, the robotic device that is equipped with the robot hand according to the present embodiment and has a linear extension and retraction joint is described as an example. In the following description, components having a substantially same function and configuration are denoted by the same reference numerals, and redundant description thereof will be omitted unless necessary.

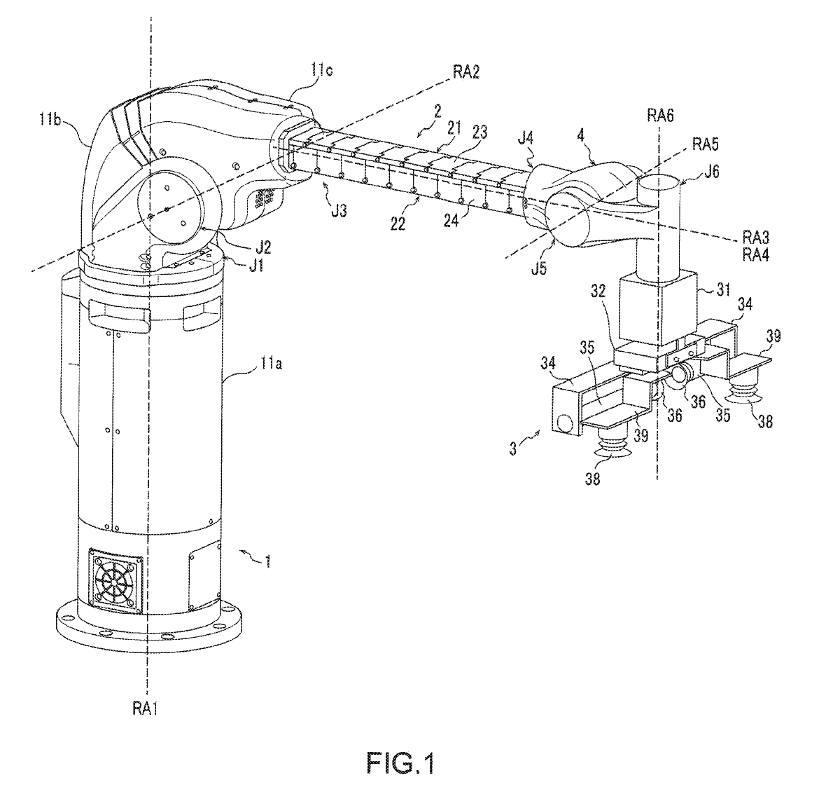

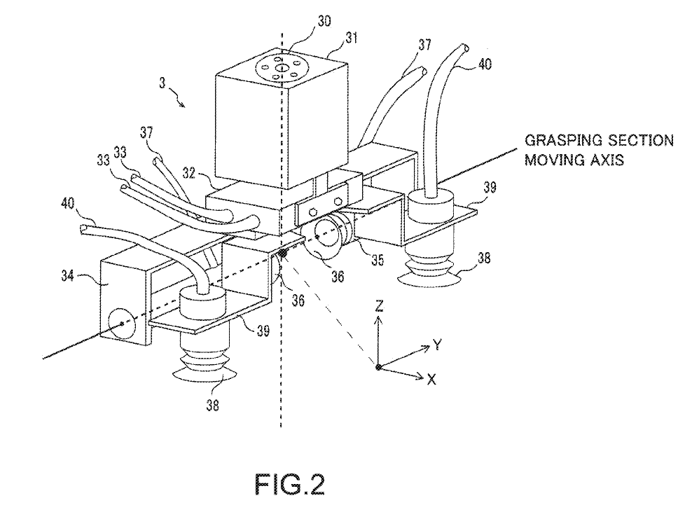

A mechanism of the robotic device equipped with a robot hand 3 according to the present embodiment is firstly described with reference to FIG. 1. FIG. 1 is an external perspective view of the robotic device equipped with the robot hand 3 according to the present embodiment. The robotic device includes a base 1 substantially cylindrical in shape and an arm section 2 connected to the base 1. A wrist section 4 is attached to a tip of the arm section 2. The wrist section 4 is provided with an adaptor not illustrated. The adapter is provided at a rotary section of a sixth axis of rotation RA6 described later. The robot hand 3 is attached via the adapter of the wrist section 4. The robot hand 3 is described in detail in FIG. 2 and the following drawings.

The robotic device has a plurality of—six herein—joints J1, J2, J3, J4, J5, and J6. The plurality of joints J1, J2, J3, J4, J5, and J6 are arranged in order from the base 1. Generally, a first, second, and third joints J1, J2, and J3 are called root three axes, and a fourth, fifth, and sixth joints J4, J5 and, J6 are called wrist three axes that change an attitude of the robot hand 3. The wrist section 4 has the fourth, fifth and sixth joints J4, J5 and J6. At least one of the joints J1, J2, and J3 constituting the root three axes is a linear motion joint. Here, the third joint J3 is constituted as a linear motion joint, a joint with a relatively long extension distance, in particular. The arm section 2 is a main component constituting the third joint J3.

The first joint J1 is a torsion joint that turns on a first axis of rotation RA1 supported, for example, perpendicularly to a base plane. The second joint J2 is a bending joint that turns on a second axis of rotation RA2 perpendicular to the first axis of rotation RA1. The third joint J3 is a joint on which the arm section 2 extends and retracts linearly along a third axis (axis of linear movement) RA3 perpendicular to the second axis of rotation RA2.

The fourth joint J4 is a torsion joint that turns on a fourth axis of rotation RA4 which matches the third axis of movement RA3. The fifth joint J5 is a bending joint that turns on a fifth axis of rotation RA5 orthogonal to the fourth axis of rotation RA4. The sixth joint J6 is a bending joint that turns on the sixth axis of rotation RA6 orthogonal to the fourth axis of rotation RA4 and perpendicular to the fifth axis of rotation RA5.

An arm support body (first support body) 11a forming the base 1 has a cylindrical hollow structure formed around the first axis of rotation RA1 of the first joint J1. The first joint J1 is mounted on a fixed base not illustrated. When the first joint J1 rotates, the first support body 11a axially rotates in accordance with the turn of the arm section 2. Note that the first support body 11a may be fixed onto a ground plane. In this case, the arm section 2 is provided to turn independently of the first support body 11a. A second support body 11b is connected to an upper part of the first support body 11a.

The second support body 11b has a hollow structure continuous with the first support body 11a. One end of the second support body 11b is attached to a rotating section of the first joint J1. The other end of the second support body 11b is open, and a third support body 11c is fitted therein pivotally on the second axis of rotation RA2 of the second joint J2. The third support body 11c has a hollow structure with a scaly exterior communicating with the first support body 11a and the second support body 11b. In accordance with bending rotation of the second joint J2, a rear part of the third support body 11c is housed in and sent out from the second support body 11b. The rear part of the arm section 2, which constitutes the linear motion joint J3 (the third joint J3) of the robotic device, is housed inside the continuous hollow structure of the first support body 11a and the second support body 11b by retraction thereof.

A lower part of a rear end of the third support body 11c is fitted in a lower part of an open end of the second support body 11b pivotally on the second axis of rotation RA2. Consequently, the second joint J2 is constituted as a bending joint that turns on the second axis of rotation RA2. When the second joint J2 pivots, the arm section 2 pivots vertically, i.e., pivots up and down, on the second axis of rotation RA2 of the second joint J2 together with the wrist section 4 and the robot hand 3.

The fourth joint J4 is a torsion joint having the fourth axis of rotation RA4 which typically matches a center axis of the arm along extension and retraction directions of the arm section 2, that is, the third axis of movement RA3 of the third joint J3. When the fourth joint J4 rotates, the robot hand 3 rotates on the fourth axis of rotation RA4 from the fourth joint J4 to the tip thereof. The fifth joint J5 is a bending joint having the fifth axis of rotation RA5 orthogonal to the fourth axis of rotation RA4 of the fourth joint J4. When the fifth joint J5 rotates, the robot hand 3 pivots up and down from the fifth joint J5 to its tip. The sixth joint J6 is a bending joint having the sixth axis of rotation RA6 orthogonal to the fourth axis of rotation RA4 of the fourth joint J4 and perpendicular to the fifth axis of rotation RA5 of the fifth joint J5. When the sixth joint J6 rotates, the robot hand 3 swings left and right.

As described above, the robot hand 3 attached to the adapter of the wrist section 4 is moved to a given position by the first joint J1, the second joint J2 and the third joint J3, and placed in a given posture by the fourth joint J4, the fifth joint J5 and the sixth joint J6. In particular, a linear extension and retraction distance of the third joint J3 enables the robot hand 3 to reach an object in a wide range from a position close to the base 1 to a position far from the base 1. The third joint J3 is characterized by the linear extension and retraction distance realized by the linear extension and retraction mechanism constituting the third joint J3.

The linear extension and retraction mechanism includes the arm section 2. The arm section 2 includes a first connection piece string 21 and a second connection piece string 22. The first connection piece string 21 is made up of a plurality of first connection pieces 23. The first connection piece 23 is constituted to be a substantially flat plate. Each pair of successive first connection pieces 23 are coupled together bendably in mutual end portions by a pin, forming a string. The first connection piece string 21 has the property of being bendable inward and outward. The second connection piece string 22 is made up of a plurality of second connection pieces 24. The second connection piece 24 is formed into a short grooved body U-shaped in cross section. Each pair of successive second connection pieces 24 are coupled together bendably in mutual bottom surface end portions by a pin, forming a string. The second connection piece string 22 has the property of being bendable inward but incapable of bending outward, due to the cross-sectional shapes of the second connection pieces 24 and the connection positions by the pins. Note that surfaces of the first connection pieces 23 and the second connection pieces 24, which face the second axis of rotation RA2, are referred to as inner surfaces, and surfaces at an opposite side thereof are referred to outer surfaces.

The leading first connection piece 23 of the first connection piece string 21 and the leading second connection piece 24 of the second connection piece string 22 are connected with each other by a head piece not illustrated. For example, the head piece has a combined shape of the first connection piece 23 and the second connection piece 24.

When the arm section 2 extends, the first and second connection piece strings 21 and 22 are sent out through an opening in the third support body 11c with the head piece not illustrated serving as a leading piece. The first and second connection piece strings 21 and 22 are joined each other in a vicinity of the opening of the third support body 11c. Rear portions of the first and second connection piece strings 21 and 22 are held firmly inside the third support body 11c, whereby the first and second connection piece strings 21 and 22 are kept joined. When the joined state of the first and second connection piece strings 21 and 22 is kept, the first connection piece string 21 and the second connection piece string 22 constrain each other from bending. The first and second connection piece strings 21 and 22 which are joined and constrain each other from bending constitute a columnar body having a certain degree of rigidity. The columnar body refers to a columnar rod body which is formed by the joined first and second connection piece strings 21 and 22.

When the arm section 2 is retracted, the first and second connection piece strings 21 and 22 are returned to the opening of the third support body 11c. The first and second connection piece strings 21 and 22 constituting the columnar body are separated from each other inside the third support body 11c. Each of the separated first and second connection piece strings 21 and 22 is returned to a bendable state, bent individually, and stored in the first support body 11a.

### (Structure of Robot Hand 3)

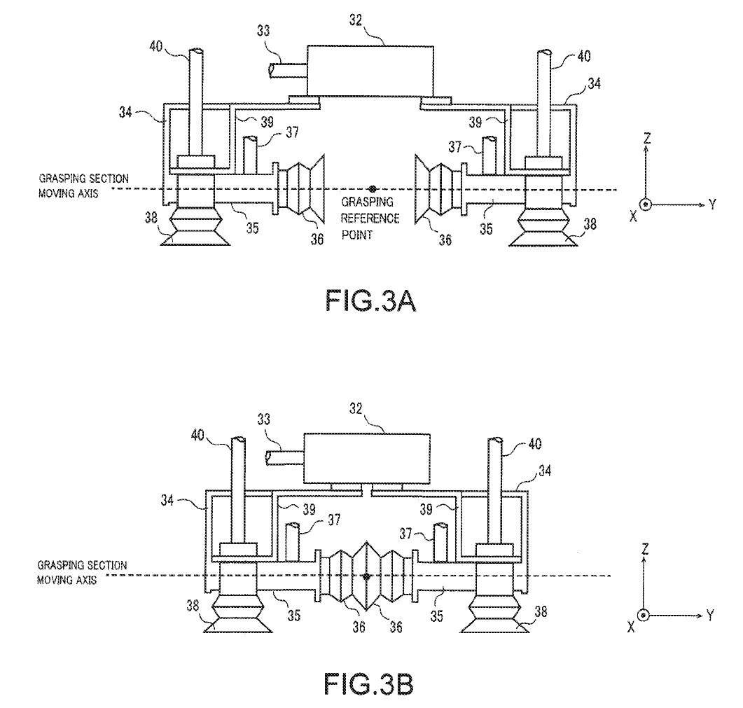

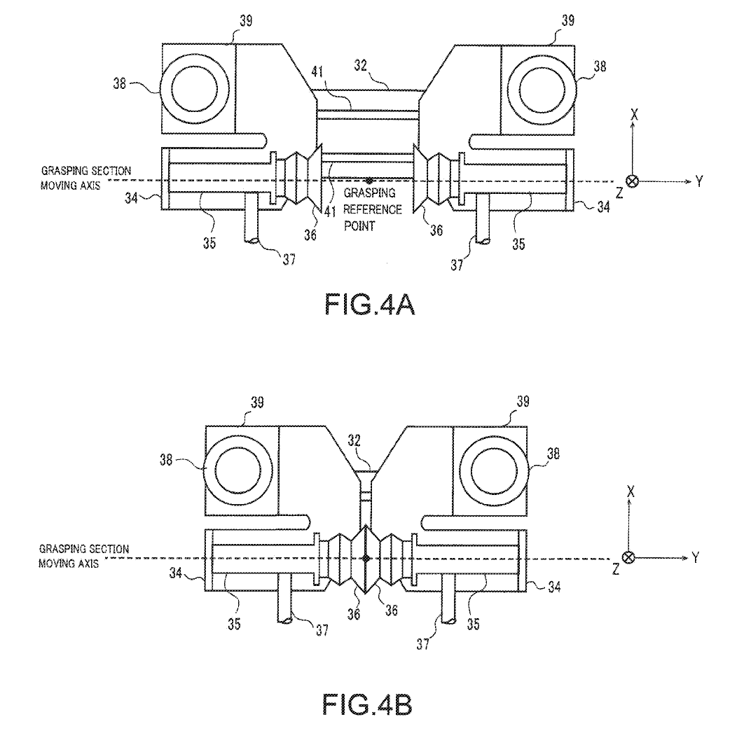

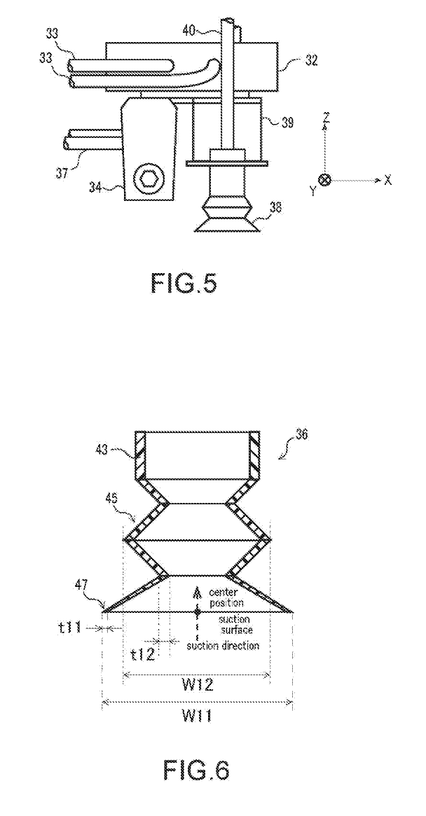

Next, a structure of the robot hand 3 according to the present embodiment is described with reference to FIGS. 2 to 6. FIG. 2 is an external perspective view of the robot hand 3 in FIG. 1. FIGS. 3A and 3B are front views of the robot hand 3 in FIG. 2. FIGS. 4A and 4B are bottom views of the robot hand 3 in FIG. 2. FIG. 5 is a side view of the robot hand 3 in FIG. 2. FIG. 6 is a vertical sectional view of a vacuum suction section 36 of the robot hand 3 in FIG. 2. Note that for convenience of explanation, a space coordinate system is defined as illustrated in FIG. 2 to FIG. 5. That is, as illustrated in FIG. 3B and FIG. 4B, a position where center positions of contact surfaces of a pair of contact sections 36 described later overlap each other is defined as a grasping reference point (an original point), an axis passing through the grasping reference point and parallel with a direction in which the piston reciprocates is defined as a Y axis (a grasping section moving axis), an axis connecting the grasping reference point and a center position of an attaching section 30 of a hand main body 31 is defined as a Z axis, and an X axis orthogonal to the Y axis and Z axis is defined.

The robot hand 3 has the hand main body 31. The hand main body 31 has a prismatic shape, and the attaching section 30 is provided on an upper end surface of the hand main body 31. The robot hand 3 is fitted to the robotic device by the attaching section 30 of the hand main body 31 being connected to the adapter equipped at the wrist section 4. A pneumatic chuck section 32 is attached at a lower part of the hand main body 31. The pneumatic chuck section 32 includes an air cylinder not illustrated as an actuator. The air cylinder is disposed so that a piston moving axis becomes parallel with a Y-axis direction. Compressed air is supplied in two phases to the air cylinder from a pair of air tubes 33. The pair of air tubes 33 are connected to an air compressor. When the air compressor drives, and an electromagnetic valve corresponding to the air tube 33 is opened, the compressed air is supplied to the air cylinder. The electromagnetic valve is controlled by an electromagnetic valve control section not illustrated. Thereby, a pair of pistons included in the air cylinder reciprocate in opposite directions from each other in the Y-axis direction. A grasping frame 34 and a suction frame 39 are attached to each of the pair of pistons via a connection member. A pair of grasping frames 34 (a pair of suction frames 39) are moved in directions to move close to and separate from each other along a rail 41 provided on the pneumatic chuck section 32 by reciprocating movement of the pair of pistons.

Note that to the aforementioned air compressor, air tubes 37 and 40 described later are connected in addition to the pair of air tubes 33. Electromagnetic valves respectively corresponding to the air tubes 33, 37 and 40 are controlled by the electromagnetic valve control section, whereby the air compressor can be shared, and contribution to cost reduction can be made.

The grasping frame 34 holds the grasping section 35. The grasping section 35 holds a contact section 36. A pair of grasping frames 34, a pair of grasping sections 35 and a pair of contact sections 36 (hereunder, collectively referred to as a grasping mechanism) are configured so that contact surfaces of the pair of contact sections 36 move in directions to move close to and separate from each other with the reciprocating movement of the pistons. Specifically, the grasping mechanism is configured so that the mutual contact surfaces are disposed to face each other, and a direction (hereunder, referred to as a grasping direction) of an axis (the grasping section moving axis) connecting the center positions of the mutual contact surfaces become parallel with the direction of the reciprocating movement of the piston. For example, the grasping mechanisms is configured as follows.

As illustrated in FIGS. 2 to 5, the grasping frame 34 is a flat plate of a metal, a resin or the like and having a substantially L-shape. One end of the grasping frame 34 is attached to the piston via a connection member. Specifically, the grasping frame 34 is attached to the piston so that both side surfaces of the grasping frame 34 are disposed parallel with an XZ plane. Further, the grasping frames 34 are attached to the pistons so that mutual bent portions are disposed to face outward. Further, the grasping frames 34 are attached to the piston so that the other end faces a negative direction of the Z axis. A rear end surface of the grasping section 35 is vertically attached to a predetermined position of a back surface of the other end portion of the grasping frame 34. The grasping section 35 is a rod body in a substantially columnar shape. Positions to which the rear end surfaces of the pair of grasping sections 35 are attached are same positions as each other with respect to the X-axis direction and the Z-axis direction. The contact section 36 is attached to a predetermined position of a tip end surface (a grasping surface) of the grasping section 35. Positions to which the pair of contact sections 36 are attached are same positions as each other with respect to the X-axis direction and the Z-axis direction. According to the grasping mechanism of the robot hand 3 according to the present embodiment described above, the contact surfaces of the pair of contact sections 36 are disposed to face each other, and the grasping direction can be made parallel with the Y-axis direction.

As illustrated in FIG. 6, in the present embodiment, as the contact section 36, a vacuum suction section (hereunder, referred to as the vacuum suction section 36) including flexibility is used. An attaching pad 43 of the vacuum suction section 36 is connected to the grasping surface of the grasping section 35. The vacuum suction section 36 has a bellows shape, and preferably has 1.5 folds. An outside diameter W11 of a suction portion 47 of the vacuum suction section 36 is larger than an outside diameter (fold diameter) W12 of a crest portion 45. A pad thickness t11 in the suction portion 47 is thinner than a pad thickness of the other portions, for example, a pad thickness t12 of the crest portion 45 of the vacuum suction section 36. The vacuum suction section 36 is connected to the compressor already described via the air tube 37. When the compressor is driven in a state where the suction surface 47 of the vacuum suction section 36 is in close contact with a workpiece, air in a space defined by the workpiece and the vacuum suction section 36 is sucked, and negative pressure works onto the workpiece. As a result, the workpiece is sucked by the vacuum suction section 36.

The suction frame 39 holds another vacuum suction section 38 (hereunder, simply referred to as the vacuum suction section 38). A pair of suction frames 39 and a pair of vacuum suction sections 38 (hereunder, referred to as a suction mechanism) are configured so that suction surfaces of the vacuum suction sections 38 are on the same plane and suction directions thereof are parallel with each other. Further, the suction mechanism is configured so that a workpiece sucked by the suction surfaces of the vacuum suction sections 38 does not contact the grasping mechanism. For example, the suction mechanism is configured as follows.

As illustrated in FIGS. 2 to 5, the suction frame 39 is a flat plate in a stair shape having one step and molded of a metal, a resin or the like. One end of the suction frame 39 is attached to the piston via a connection member. Specifically, the suction frame 39 is attached to the piston so that both side surfaces thereof are disposed parallel with an XZ plane. Further, the suction frame 39 is attached to the piston so that the other end is disposed to face outward. Further, the suction frame 39 is attached to the piston so that the step of a crank lowers in a negative direction of the Z axis. The vacuum suction section 38 is vertically attached to a predetermined position of a back surface of the other end portion of the suction frame 39. Positions at which the pair of vacuum suction sections 38 are attached are the same positions as each other with respect to the X-axis direction and the Z-axis direction. According to the above suction mechanism, the suction surfaces of the vacuum suction sections 38 are on the same plane and mutual suction directions can be made parallel with each other. The suction directions are orthogonal to the grasping direction. Further, the pair of vacuum suction sections 38 are moved in the directions to move close to and separate from each other by the piston with the contact sections 36. Note that as for the vacuum suction sections 38, the vacuum suction sections 36 already described are preferably used. The vacuum suction section 38 is connected to the air compressor already described via the air tube 40.

A height of the step of the suction frame 39 and an axial length of the vacuum suction section 38 are designed so that the suction surface of the vacuum suction section 38 is lower than a lowermost end of the grasping mechanism with respect to the Z-axis direction. Thereby, the vacuum suction section 38 can cause the suction surface to suck such a workpiece without causing the workpiece to contact the grasping mechanism. Note that as illustrated in FIGS. 2 to 5, the grasping frame 34 and the suction frame 39 may be attached to the piston in a state where side surfaces of mutual one end portions are connected to each other. Further, the suction frame 39 may be fixed to the hand main body 31 or the like, for example, instead of the piston. This can decrease a weight load exerted onto the piston.

### (Grasping Action of Robot Hand 3)

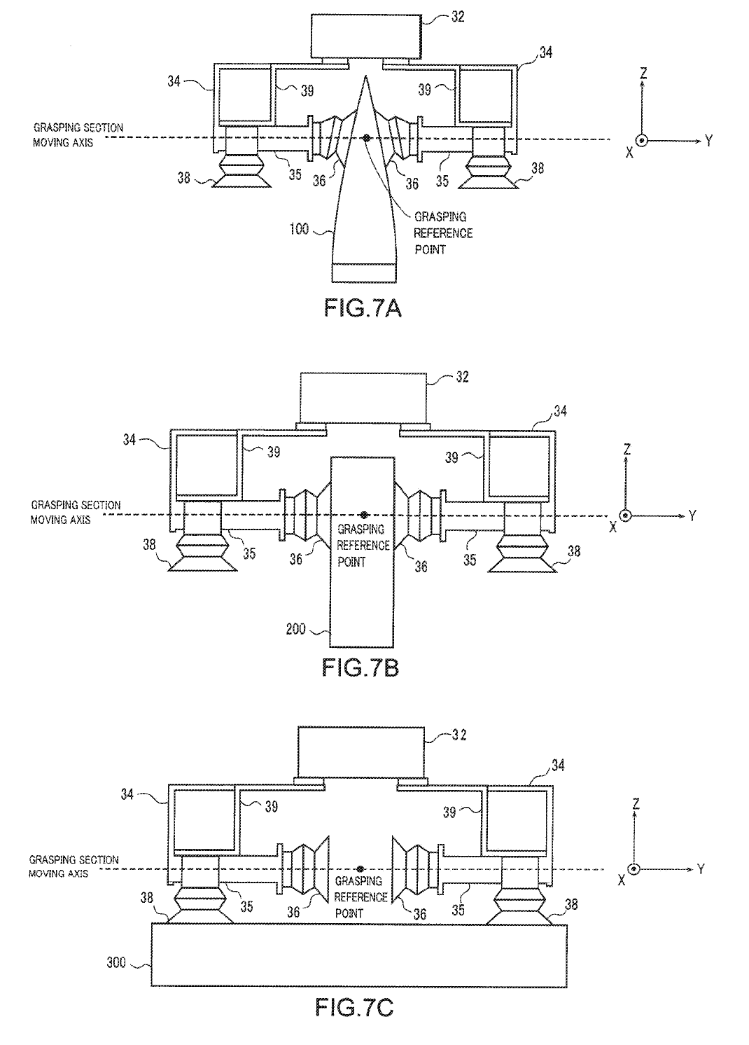

Subsequently, an action of the robot hand 3 according to the present embodiment is described with reference to FIGS. 7A to 7C. FIGS. 7A to 7C are views illustrating grasping states of workpieces by the robot hand 3 according to the present embodiment. The robot hand 3 according to the present embodiment has two mechanisms capable of grasping different kinds of workpieces. Specifically, the robot hand 3 according to the present embodiment includes the grasping mechanism mainly used for the purpose of grasping a workpiece having flexibility, and the suction mechanism that mainly sucks a workpiece having no flexibility.

First, a grasping action of the grasping mechanism of the robot hand 3 according to the present embodiment is described with reference to FIG. 7k The grasping mechanism of the robot hand 3 according to the present embodiment is mainly used for the purpose of grasping a workpiece 100 having flexibility. The workpiece 100 having flexibility is typically a tube or the like filled with a liquid, for example, that are elastically deformed when a surface is pressed.

The suction surfaces 47 of the vacuum suction sections 36 are moved in a direction to move close to each other by a reciprocating motion of the piston. At this time, the air compressor already described which is connected via the air tubes 37 is in a driving state. That is, the vacuum suction sections 36 are moved in the direction to move close to each other while performing suction actions. When the suction surface 47 of the vacuum suction section 36 starts to contact a surface of the workpiece 100, a frictional force by the suction surfaces 47 contacting the workpiece 100 is generated between the suction surfaces 47 of the vacuum suction sections 36 and the surface of the workpiece 100. At this time, bellows section portions of the vacuum suction sections 36 start to deform so that the suction surfaces 47 become parallel with the surface of the workpiece 100.

When the vacuum suction sections 36 are further moved in the directions to move close to each other, and the suction surfaces 47 of the vacuum suction sections 36 closely contact the surface of the workpiece 100, forces that press the suction surfaces 47 to the workpiece 100 from both sides increase, and the frictional forces between the suction surfaces 47 and the surface of the workpiece 100 increase. The forces that press the suction surfaces 47 to the workpiece 100 from both sides correspond to distances by which the suction surfaces 47 of the vacuum suction sections 36 move in the direction to move close to each other. Further, when the suction surfaces 47 of the vacuum suction sections 36 closely contact the surface of the workpiece 100, the frictional forces are generated between the suction surfaces 47 and the surface of the workpiece 100 by the vacuum suction sections 36 sucking the workpiece 100.

Accordingly, the grasping mechanism of the robot hand 3 according to the present embodiment can grasp the workpiece 100 with a sum frictional force of a frictional force that is generated between the suction surfaces 47 and the workpiece 100 by pressing the suction surfaces 47 to the workpiece 100 from both sides, and a frictional force that is generated between the suction surfaces 47 and the workpiece 100 by the vacuum suction sections 36 sucking the workpiece 100. In other words, the grasping mechanism of the robot hand 3 according to the present embodiment can increase the frictional force that is generated between the suction surfaces 47 and the surface of the workpiece 100 by pressing the suction surfaces 47 to the workpiece 100 from both sides, by pressing the suction surfaces 47 to the workpiece 100 and sucking the workpiece 100.

Accordingly, the grasping mechanism of the robot hand 3 according to the present embodiment can grasp various kinds of workpieces 100 by adjusting the forces that press the suction surfaces 47 to the workpiece 100 from both sides and the forces that suck the workpiece 100. Further, the vacuum suction sections 36 attached to the grasping sections 35 of the grasping mechanism of the robot hand 3 according to the present embodiment have the bellows section portions. Consequently, the grasping mechanism of the robot hand 3 according to the present embodiment can bring the suction surfaces 47 in close contact with various workpieces 100 having different surface shapes and flexibilities, and can grasp the workpiece 100 while sucking the workpiece 100. Furthermore, for example, by changing the vacuum suction sections 36 in the present embodiment to the vacuum suction sections 36 having bellows section portions with 2.5 folds, the flat vacuum suction sections 36 or the like, the vacuum suction sections 36 can respond to various workpieces 100 with different surface shapes and flexibilities.

For example, in the case of the workpiece 100 having flexibility as in the present embodiment, the forces that press the suction surfaces 47 to the workpiece 100 from both sides can be decreased, and the forces that suck the workpiece 100 can be increased. Specifically, the distance by which the suction surfaces 47 of the vacuum suction sections 36 are moved in the directions to move close to each other is set at the distance that is required to bring the suction surfaces 47 of the vacuum suction sections 36 into close contact with the surface of the workpiece 100, and the suction forces of the vacuum suction sections 36 are set at the frictional forces required for the sum frictional force to grasp the workpiece 100. In the grasping mechanism of the robot hand 3 according to the present embodiment, the reason why the suction surfaces 47 are pressed to the workpiece 100 from both sides is mainly to bring the suction surfaces 47 into close contact with the surface of the workpiece 100. That is, the grasping mechanism of the robot hand 3 according to the present embodiment presses the suction surfaces 47 to the workpiece 100 from both sides to bring the suction surfaces 47 into close contact with the surface of the workpiece 100, and sucks the workpiece 100 to grasp the workpiece 100. Thereby, the grasping mechanism of the robot hand 3 according to the present embodiment can grasp the workpiece 100 having flexibility in a state where elastic deformation of the surface thereof is suppressed.

The grasping mechanism of the robot hand 3 according to the embodiment may be used for the purpose of grasping a workpiece having no flexibility. As illustrated in FIG. 7B, the grasping mechanism of the robot hand 3 according to the present embodiment also can grasp a workpiece 200 having no flexibility, for example, a rod body in a substantially rectangular column shape, a metal body having a substantially triangular pyramid shape and the like, for example, by the grasping action already described. Note that when the grasping mechanism of the robot hand 3 according to the embodiment is used to grasp the workpiece 200 having no flexibility, the vacuum suction sections 36 having flat shapes are attached to the grasping sections 35, and the grasping sections 35 may be used. Further, electromagnets may be used as the contact sections. The electromagnets are attached to the grasping surfaces of the grasping sections 35, whereby the workpiece can be grasped with magnetic forces, and released.

Next, a suction action of the suction mechanism of the robot hand 3 according to the present embodiment is described with reference to FIG. 7C. The suction mechanism of the robot hand 3 according to the present embodiment is mainly used for the purpose of grasping a workpiece 300 having no flexibility.

The suction surfaces of the vacuum suction sections 38 are pressed to the workpiece 300 by a plurality of joints included by the robotic device, and closely contact the workpiece 300. The air compressor already described is driven, and the suction action of the pair of vacuum suction sections 38 is performed, whereby the workpiece 300 is sucked in the suction direction. Thereby, the suction mechanism of the robot hand 3 according to the present embodiment can suck and hold the workpiece 300 having no flexibility. Further, the pair of vacuum suction sections 38 are moved in the directions to move close to and separate from each other by the reciprocating movement of the piston. Thereby the suction mechanism of the robot hand 3 according to the present embodiment can such and hold a plurality of kinds of workpieces 300 having different dimensions (widths or lengths).

As described above, the robot hand 3 according to the present embodiment includes the two mechanisms that are the grasping mechanism that is mainly used for the purpose of grasping the workpiece having flexibility and the suction mechanism that is mainly used for the purpose of sucking and holding the workpiece having no flexibility. Accordingly, the robot hand 3 according to the present embodiment can be said as a robot hand with high versatility that responds to various kinds of workpieces.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A robot hand, comprising:
a pair of grasping sections adapted to grasp a workpiece, the pair of grasping sections being disposed to face each other;
a pair of workpiece contact sections attached to the pair of grasping sections; and
a moving mechanism adapted to move the pair of grasping sections in directions to move close to and separate from each other,
wherein the workpiece contact sections are vacuum suction sections having flexibility.

2. The robot hand according to claim 1,
wherein each of the vacuum suction sections includes a bellows shape.

3. The robot hand according to claim 2,
wherein the bellows shape has 1.5 folds.

4. The robot hand according to claim 3,
wherein each of the vacuum suction section has a suction portion with an outside diameter larger than a fold diameter.

5. The robot hand according to claim 1,
wherein the moving mechanism includes an air cylinder.

6. The robot hand according to claim 1,
wherein the pair of vacuum suction sections are attached to the pair of grasping sections respectively to face each other in such a manner that suction directions are opposite to each other.

7. The robot hand according to claim 1,
wherein the pair of vacuum suction sections are attached to the pair of grasping sections respectively in such a manner that suction directions are parallel with directions in which the pair of grasping sections move close to and separate from each other.

8. The robot hand according to claim 1, further comprising:
a pair of other vacuum suction sections,
wherein suction directions of the pair of other vacuum suction sections are parallel with each other, and are orthogonal to the directions in which the pair of grasping sections move close to and separate from each other.

9. The robot hand according to claim 8,
wherein the pair of other vacuum suction sections are moved in directions to move close to and separate from each other by the moving mechanism, with the pair of grasping sections.

10. A robot hand, comprising:
a pair of grasping sections adapted to grasp a workpiece, the pair of grasping sections being disposed to face each other;
a pair of workpiece contact sections attached to the pair of grasping sections;
a moving mechanism adapted to move the pair of grasping sections in directions to move close to and separate from each other, and
a pair of vacuum suction sections connected to the pair of grasping sections so that suction directions are parallel with each other, and are orthogonal to the directions in which the pair of grasping sections to which the suction directions are orthogonal move close to and separate from each other.
